(19) United States
(12) Patent Application Publication
(10) Pub. No.: US 2012/0304657 A1
(43) Pub. Date: Dec. 6, 2012

(54) LOCK LEAF HULA SEAL

(75) Inventors: Patrick Benedict MELTON, Horse Shoe, NC (US); Keith Cletus Belsom, Laurens, SC (US); Thomas Edward Johnson, Greenville, SC (US); William Lawrence Byrne, Simpsonville, SC (US); Robert Joseph Rohrssen, Simpsonville, SC (US)

(73) Assignee: General Electric Company, Schenectady, NY (US)

(21) Appl. No.: 13/153,987

(22) Filed: Jun. 6, 2011

(51) Int. Cl. F02C 7/28; F16J 15/06

(52) U.S. Cl. 60/752; 277/654

(57) ABSTRACT

A flexible annular seal for insertion between concentrically assembled turbine combustor components includes an annular inner seal portion having a first solid annular edge and first plurality of spring fingers extending axially from the first solid annular edge; and an annular outer seal portion having a second solid annular edge and a second plurality of spring fingers extending axially from the second solid edge and overlying the first plurality of spring fingers such that the inner and outer seal portions are substantially fully engaged along an entire length dimension of the flexible annular seal. The second plurality of spring fingers are circumferentially offset from the first plurality of spring fingers, and free ends of the first plurality of spring fingers are bent around and over free ends of the second plurality of spring fingers.

### BACKGROUND

This invention relates to gas turbine combustor components generally, and specifically, to flexible annular seals utilized between concentrically-assembled gas turbine combustor components.

Currently, annular, flexible spring finger seals (also known as hula seals) are used to provide concentricity control between co-annular parts, while providing effective sealing performance. Hula seals are circumferential metal seals that are slotted in the axial direction and contoured to be spring-loaded between inner and outer diameters of mating parts that experience relative axial motion. Double-leaf hula seals, which include two layers of spring fingers that are offset in a circumferential direction, provide more stiffness and better sealing capabilities. The two most common and critical locations where such seals are employed are radially between the combustion chamber liner aft end and the transition piece forward end (i.e., between the outer diameter (OD) of the liner and the inner diameter (ID) of the transition piece), as well as between the combustor cap aft end and the combustion chamber liner forward end (i.e., between the OD of the cap and the ID of the liner). Other locations include between the flow sleeve that surrounds the liner and the compressor discharge casing (i.e., between the flow sleeve OD and the casing ID).

Historically, when the inner member, e.g. the combustor cap, was inserted into the outer member, e.g., the combustion chamber liner (or simply, combustor liner), the free ends of the spring-fingers or leaves of the hula seal located on the outside diameter of the inner member would be damaged. Specifically, the outer leaves would catch on the outer member and become bent and unusable in some cases. In addition, some hula seals have become unloaded due to out-of-roundness during operation, severe misalignment or adverse loading. When the spring seal leaves become unloaded, they are more prone to vibrate and fail in High Cycle Fatigue (HCF), which can result in foreign-object damage downstream. It has also been found that the weld by which the hula seal is secured is prone to cracking when the weld end of the hula seal is exposed to high combustion temperatures.

There remains a need, therefore, for a hula seal configuration that prevents damage to the free ends of the seal spring fingers, particularly upon assembly, and that permits the seal weld to be located in a cooler zone.

### BRIEF SUMMARY OF THE INVENTION

Accordingly, in one exemplary but nonlimiting embodiment, there is provided a flexible annular seal for insertion between concentrically assembled turbine combustor components comprising an annular inner seal portion having a first solid annular edge and first plurality of spring fingers extending axially from the first solid annular edge; an annular outer seal portion having a second solid annular edge and a second plurality of spring fingers extending axially from the second solid edge and overlying the first plurality of spring fingers such that the inner and outer seal portions are substantially fully engaged along an entire length dimension of the flexible annular seal, the second plurality of spring fingers being circumferentially offset from the first plurality of spring fingers; and wherein free ends of first plurality of spring fingers are bent around and over free ends of the second plurality of spring fingers, thereby forming a rolled edge at an end opposite said first and second solid annular edges.

In another exemplary but nonlimiting embodiment, there is provided a gas turbine combustor assembly comprising an inner annular component telescopically received within an outer annular component and a flexible annular seal located radially between the inner and outer annular components and fixed to the radially inner annular component, the flexible seal comprising an annular inner seal portion having a first solid annular edge and a first plurality of spring fingers extending axially from the first solid edge; an annular outer seal portion having a second solid annular edge fixed, and the to the first solid annular edge, and a second plurality of spring fingers extending axially from the second solid edge and overlying the first plurality of spring fingers, and overlying the first plurality of spring fingers such that the inner and outer seal portions are substantially fully engaged along an entire length dimension of the flexible annular seal, the second plurality of spring fingers being circumferentially offset from the first plurality of spring fingers; and wherein free ends of first plurality of spring fingers are bent around and over free ends of the second plurality of spring fingers.

In still another exemplary but nonlimiting embodiment, there is provided the gas turbine combustor assembly comprising a combustor end cap attached to a forward end of a combustor liner, and a transition piece attached to an aft end of the combustor liner; first and second annular flexible seals located radially between the combustor end cap and the forward end of the combustor liner, and between the transition piece and the aft end of the combustor liner, respectively; each of the first and second annular flexible seals comprising an annular inner seal portion having a first solid annular edge and first plurality of spring fingers extending axially from the first solid annular edge; and an annular outer seal portion having a second solid annular edge and a second plurality of spring fingers extending axially from the second solid edge and overlying the first plurality of spring fingers such that the inner and outer seal portions are substantially fully engaged along an entire length dimension of the flexible annular seal, the second plurality of spring fingers being circumferentially offset from the first plurality of spring fingers; and wherein free ends of first plurality of spring fingers are bent to form a rolled edge extending around and over free ends of the second plurality of spring fingers.

The invention will now be described in detail in connection with the drawings identified below.

### BRIEF DESCRIPTION OF THE DRAWINGS

FIG. 1 is a perspective view of a hula seal in accordance with an exemplary but nonlimiting embodiment of the invention;

FIG. 2 is an enlarged detail taken from FIG. 3;

FIG. 3 is a partial cross-section showing the hula seal of FIG. 1 installed at the interface between a combustor cap and a combustor liner; and

FIG. 4 is a partial cross-section showing the hula seal of FIG. 1 installed at the interface between a combustor liner and a transition piece.

### DETAILED DESCRIPTION OF THE INVENTION

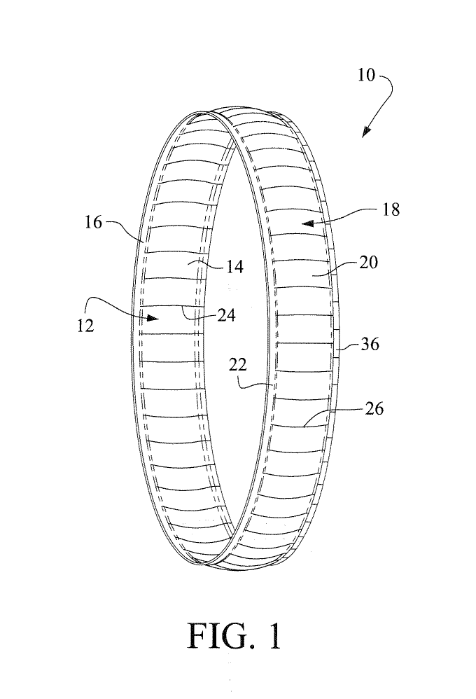

With reference initially to FIG. 1, a hula seal 10 in accordance with an exemplary but nonlimiting embodiment of the invention is comprised of an inner seal portion 12 formed by a plurality of axially-oriented, convexly bowed spring fingers 14 connected along a solid annular edge or ring 16. An outer seal portion 18 overlies the inner seal portion and, similarly, contains a plurality of axially-oriented, convexly-bowed spring fingers 20 connected along a solid annular edge or ring 22. The spring fingers 14 of the inner seal portion 12 are circumferentially offset from the spring fingers 20 of the outer seal portion 18 so that the respective slots 24, 26, are overlapped as best seen in FIG. 1. Note also that the spring fingers of the inner and outer seal portions 12, 18 are substantially fully engaged along the entire axial length of the seal, except for extended ends of the spring fingers 14 of the inner seal portion 12 used to lock the free ends of the spring fingers 20 of the outer seal portion 18 as described further below. The solid rings 16 and 22 are spot welded near the slots 24, 26 but the spring fingers 14 and 20 are otherwise able to move relatively to each other. The inner and outer seal portions are made from metal spring material such as Inconel X750 or other suitable high temperature metals. The outer spring fingers 20 may have a conventional wear-resistant coating applied at least to the outer surfaces thereof since they engage the co-annular part and are thus subject to constant rubbing and vibration.

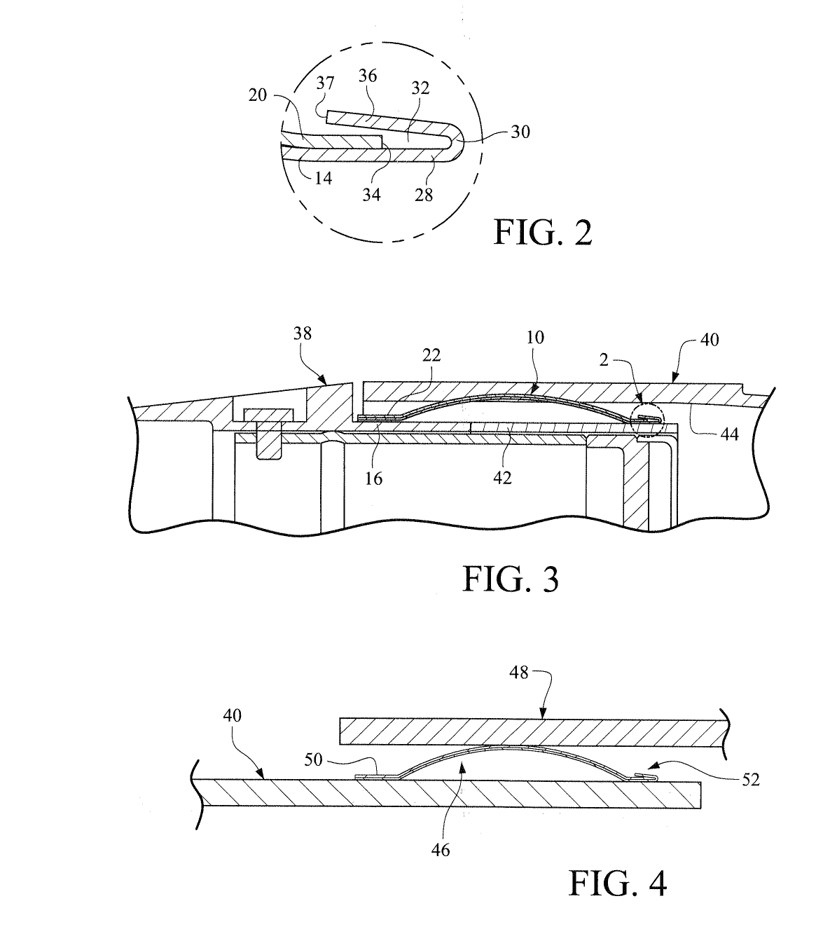

The spring fingers 14 of the inner seal portion 12 are extended in the axial direction as at 28, and are bent around and over the outer seal fingers 20, thereby forming a rolled edge 30 as best seen in FIG. 2. Note, the axial gap 32 between the free edge 34 of the inner spring fingers 14 and the rolled edge 30 which allows the spring fingers 20 of the outer seal portion 18 to continue to move axially relative to the spring fingers 14 of the inner seal portion 12 while preventing unwanted bending back or peeling of the outer spring fingers 20 during assembly. By providing a properly-sized axial gap 32, the effective spring rate of the seal remains unchanged.

The resulting locking flanges 36 of the inner seal spring fingers 14 protect the free ends of the outer leaf seal fingers 20 particularly during assembly. Note in this regard that the free ends 37 of the locking flanges 36 are also not exposed to the edge of the component into which it is inserted, as further described below. The overlapping lock also provides greater hoop strength to the seal.

While the hula seal described above is comprised of two overlapping seal portions, the invention contemplates the use of more than two overlapping seal portions for some applications, using a similar locking technique for protecting the free ends of the spring fingers.

With reference now to FIG. 3, in an exemplary but nonlimiting embodiment, the hula seal 10 is located at the interface between a combustor cap 38 and a combustor liner 40. In a typical combustor configuration, the liner is surrounded by a flow sleeve (not shown) that establishes a flow path or annulus radially between the liner and the flow sleeve for compressor discharge cooling air that is ultimately supplied to the combustor. The liner forward end is held concentric with the cap, and the hula seal regulates the cooling air flow from the flow sleeve/liner annulus to the hot combustion gases. In this embodiment, the hula seal 10 is welded to the end cap outer barrel 42, on an exterior side thereof, with the welded end located away from the aft edge of the cap. The end cap 38 is telescoped into the forward end of the liner 40, with the outwardly bowed spring fingers 14, 20 of the hula seal 10 engaged with the inner surface 44 of the liner. The hula seal is thus free to slide axially relative to the liner, and the spring fingers are free to slide relative to the cap. By locating the welded end of the hula seal in a cooler zone (i.e., farther away from the combustion chamber than the opposite end of the seal) the potential for cracking along the welded edge due to high temperatures is reduced. At the same time, by wrapping the free ends of the outer spring fingers 20 with the extended free ends 28 of the inner spring fingers 14, the free ends and edges 34 of the outer spring fingers 20 are protected during insertion of the cap into the liner. In addition, by bending back the extended free ends 28 of inner spring fingers 14, the free edges 37 of the spring fingers 14 are not exposed to the edge of the liner 40 into which the cap 38 is inserted. In this regard, it is of no concern whether the cap 38 is inserted into the liner 40 or the liner is telescoped over the cap.

FIG. 4 illustrates in simplified form the opposite end of the liner 40, and specifically the orientation of another hula seal 46 (similar to hula seal 10) welded to the aft end of the liner which is inserted into the forward end of a transition piece 48. The seal 46 is free to move relative to the transition piece 48, and the spring fingers are free to slide on the liner 40. Here again, the weld end 50 of the hula seal is located in a cooler zone, away from the edge of the liner, and the protected free end 52 prevents damage during assembly as described above in connection with FIG. 3.

The hula seal configuration described herein provides several advantages; it allows placement of the hula seal in the direction most beneficial for robust design, without regard for assembly direction; it increases seal and weld fatigue life; it eliminates assembly damage; it decreases the amount of performance-decreasing cooling air because additional cooling air is not required to cool the welded ends of the seal; and it provides enhanced vibration damping by coupling the adjacent inner and outer spring fingers, thus decreasing possible HCF damage.

Accordingly, by providing a mechanism by which the free ends of the hula seal spring fingers can be protected during assembly, it is also possible to orient the hula seal with the opposite weld end always located away from the hotter free end of the component to which it is secured.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A flexible annular seal for insertion between concentrically assembled turbine combustor components comprising:
an annular inner seal portion having a first solid annular edge and first plurality of spring fingers extending axially from said first solid annular edge;
an annular outer seal portion having a second solid annular edge and a second plurality of spring fingers extending axially from said second solid edge and overlying said first plurality of spring fingers such that said inner and outer seal portions are substantially fully engaged along an entire length dimension of said flexible annular seal, said second plurality of spring fingers being circumferentially offset from said first plurality of spring fingers; and
wherein free ends of first plurality of spring fingers are bent around and over free ends of said second plurality of spring fingers, thereby forming a rolled edge at an end opposite said first and second solid annular edges.

2. The flexible annular seal of claim 1 wherein said first and second solid annular edges are welded together.

3. The flexible annular seal of claim 1 wherein an axial gap is provided between the free ends of the second plurality of spring fingers and the rolled edge in the first plurality of spring fingers.

4. The flexible annular seal of claim 1 wherein said first and second pluralities of spring fingers are radially outwardly bowed substantially between said first and second solid edges and said rolled edge.

5. A gas turbine combustor assembly comprising:
an inner annular component telescopically received within an outer annular component and a flexible annular seal located radially between the inner and outer annular components and fixed to said radially inner annular component, the flexible seal comprising an annular inner seal portion having a first solid annular edge and a first plurality of spring fingers extending axially from said first solid edge;
an annular outer seal portion having a second solid annular edge fixed to said first solid annular edge, and a second plurality of spring fingers extending axially from said second solid edge and overlying said first plurality of spring fingers, such that said inner and outer seal portions are substantially fully engaged along an entire length dimension of said flexible annular seal, said second plurality of spring fingers being circumferentially offset from said first plurality of spring fingers; and
wherein free ends of first plurality of spring fingers are bent around and over free ends of said second plurality of spring fingers.

6. The turbine combustor assembly of claim 5 wherein said flexible annular seal is welded at said first and second solid edges to said inner component at a location removed from a free end of the inner component, and wherein said free ends of said first and second pluralities of spring fingers are located adjacent said free end of said inner component.

7. The turbine combustor assembly of claim 5 wherein the first inner component comprises a combustor end cap and the second outer component comprises a combustor liner.

8. The combustor assembly of claim 5 wherein the first inner component comprises a combustor liner and the second outer component comprises a combustor transition piece.

9. The combustor assembly of claim 5 wherein an axial gap is provided between the free ends of the second plurality of spring fingers and a rolled edge in the first plurality of spring fingers sufficient to permit relative sliding movement between said first and second pluralities of spring fingers.

10. The combustor assembly of claim 5 wherein said first and second pluralities of spring fingers are radially outwardly bowed.

11. The combustor assembly of claim 6 wherein said first inner component comprises a combustor end cap and said second outer component comprises a combustor liner.

12. The combustor assembly of claim 6 wherein the first inner component comprises a combustor liner and the second outer component comprises a combustor transition piece.

13. A gas turbine combustor assembly comprising a combustor end cap attached to a forward end of a combustor liner, and a transition piece attached to an aft end of said combustor liner; first and second annular flexible seals located radially between said combustor end cap and said forward end of said combustor liner, and between said transition piece and said aft end of said combustor liner, respectively; each of said first and second annular flexible seals comprising an annular inner seal portion having a first solid annular edge and first plurality of spring fingers extending axially from said first solid annular edge; and an annular outer seal portion having a second solid annular edge and a second plurality of spring fingers extending axially from said second solid edge and overlying said first plurality of spring fingers such that said inner and outer seal portions are substantially fully engaged along an entire length dimension of said flexible annular seal, said second plurality of spring fingers being circumferentially offset from said first plurality of spring fingers; and
wherein free ends of first plurality of spring fingers are bent to form a rolled edge extending around and over free ends of said second plurality of spring fingers.

14. The gas turbine combustor assembly of claim 13 wherein said first flexible annular seal is welded at one end to an aft end of said end cap such that said one end is located farther from a free edge of said aft end of said cap than said free ends of said first and second pluralities of spring fingers of said first flexible annular seal.

15. The gas turbine combustor assembly of claim 13 wherein said second flexible annular seal is welded at one end to an aft end of said liner such that said one end is located farther from a free edge of said aft end of said liner than said free ends of said first and second pluralities of spring fingers of said second flexible annular seal.

16. The gas turbine combustor assembly of claim 13 wherein, for each of said first and second flexible annular seals, an axial gap is provided between the free ends of the second plurality of spring fingers and the rolled edge in the first plurality of spring fingers sufficient to permit relative sliding movement between said first and second pluralities of spring fingers.

17. The gas turbine combustor assembly of claim 13 wherein, for each of said first and second flexible annular seals, said first and second pluralities of spring fingers are radially outwardly bowed.

18. The gas turbine combustor assembly of claim 1 wherein at least outer surfaces of said second plurality of spring fingers are coated with a wear-resistant coating material.

19. The gas turbine combustor assembly of claim 5 wherein at least outer surfaces of said second plurality of spring fingers are coated with a wear-resistant coating material.

20. The gas turbine combustor assembly of claim 13 wherein at least outer surfaces of said second plurality of spring fingers are coated with a wear-resistant coating material.
